(19) United States
(12) Patent Application Publication
(10) Pub. No.: US 2014/0093683 A1
(43) Pub. Date: Apr. 3, 2014

(54) DECORATIVE PRODUCT INCLUDING PLASMON FILM AND METHOD OF MANUFACTURING THE SAME

(71) Applicant: Toyoda Gosei Co., Ltd., Kiyosu-shi (JP)

(72) Inventors: Motoshi OGISU, Kiyosu-shi (JP); Takayasu IDO, Kiyosu-shi (JP)

(21) Appl. No.: 13/939,244

(22) Filed: Jul. 11, 2013

(30) Foreign Application Priority Data
Sep. 28, 2012 (JP) 2012-217930

(51) Int. Cl. G02B 5/00

(52) U.S. Cl. CPC G02B 5/008
USPC 428/142; 428/148; 204/192.14

(57) ABSTRACT

The present invention provides a decorative product including a plasmon film, which includes a water repellent layer and a metal nanoparticle layer as the plasmon film stacked on the water repellent layer.

### TECHNICAL FIELD

The present invention relates to a decorative product including a plasmon film exhibiting a plasmon resonance phenomenon to produce color.

### BACKGROUND ART

In recent years, transparent front grilles using transparent substrates have increasingly been used. The applicant of the present invention is now developing and examining techniques for applying shiny decoration on the back surface of the transparent substrate in response to such needs. When the back surface of the transparent substrate is provided with shiny (metallic) decoration, decoration is generally applied by dry film formation. In particular when the shiny decoration is to be colored, it is most effective to add a color filter such as an interference film by a dry process. The color filter of the interference film, however, has a disadvantage that the color varies with view angles. The inventors of the present invention then decided to use not a color filter of an interference film but a color filter of a plasmon film that exhibits a plasmon resonance phenomenon to produce color.

The plasmon resonance phenomenon occurs at an interface between dielectric and metal and is generally known to be exhibited by forming nanoparticles of particular metals. More specifically, the metal nanoparticle resonates with visible light of particular wavelengths and absorbs only the visible light of particular wavelengths to produce color in which only the visible light of particular wavelengths is removed from white light. The resonant particular wavelengths are determined depending on the material (element), shape, size, density, etc. of metal nanoparticles, and the colors produced vary accordingly. For example, if the material (element), shape, and density are the same, a metal nanoparticle having a smaller size resonates with light of higher frequencies to absorb only such light, thereby producing color such as yellow; whereas a metal nanoparticle having a larger size resonates with light of lower frequencies to absorb only such light, thereby producing color such as blue.

In production of a plasmon film exhibiting such plasmon resonance phenomenon, a plasmon film is usually formed by coating a metal nanoparticle with a dielectric film by a wet process of applying a coating liquid (solvent) including metal nanoparticles and dielectric (transparent matrix) onto a transparent substrate as described in Patent Literatures 1 and 2.

### CITATION LIST

### Patent Literature

Patent Literature 1: Japanese Patent Application Publication No. 2000-103644 (JP 2000-103644 A)

Patent Literature 2: Japanese Patent Application Publication No. 2008-203377 (JP 2008-203377 A)

### SUMMARY OF INVENTION

### Technical Problem

The production of a plasmon film in such a wet process results in wasted coating liquid and high environmental load. The inventors of the present invention then studied depositing metal nanoparticles on the surface of a dielectric layer by sputtering. With the deposition by sputtering, however, metal nanoparticles cannot keep their particle shape and become flattened or combine with adjacent particles, so that exhibition of the plasmon resonance phenomenon is deteriorated and color production is degraded. Accordingly, shiny color films as desired by customers cannot be formed. The degradation in color production is more prominent in a blue plasmon film that requires metal nanoparticles having a relatively large size than in a yellow plasmon film that requires metal nanoparticles having a relatively small size.

In view of the above, it is an object of the present invention to allow the particle shape of a metal nanoparticle to be kept easily and to facilitate exhibition of a plasmon resonance phenomenon.

### Solution to Problem

In order to achieve the aforementioned object, a decorative product including a plasmon film according to an aspect of the present invention is configured to include a water repellent layer and a metal nanoparticle layer as the plasmon film stacked on the water repellent layer.

Although a specific form of the decorative product including a plasmon film is not particularly limited, preferably, the decorative product includes a substrate having translucency, the water repellent layer is provided on a back surface of the substrate and has translucency, and the metal nanoparticle layer is stacked on a back surface of the water repellent layer. Preferably, a translucent layer having translucency is provided on a back surface of the metal nanoparticle layer, and a reflective layer that reflects light is provided on a back surface of the translucent layer.

The substrate is not particularly limited as long as it has translucency. Preferably, the substrate is transparent. When the substrate is transparent, it is preferably mirror-finished. The material for the substrate is not particularly limited. Examples of the material of the substrate include glass, polycarbonate (PC), and polymethyl methacrylate (PMMA).

Although the material of the water repellent layer is not particularly limited, a dielectric material is preferably used. Specific examples thereof include SiO₂, TiO₂, Al₂O₃, and SiO polymer (SiOx). Among those, SiO polymer is preferred (that is, the water repellent layer is preferably a layer formed of a SiO polymer). The SiO polymer preferably includes a methyl group. This is because the methyl group is oriented toward the metal nanoparticle layer to improve water repellency, making it easier to keep the particle shape of metal nanoparticles. The water contact angle of the water repellent layer is preferably 80° or greater, and more preferably 90° or greater, although not particularly limited thereto. The water repellent layer is preferably provided by dry film formation, although not particularly limited thereto. Specific examples thereof include vacuum evaporation, plasma polymerization, and sputtering. Among those, plasma polymerization is preferred (that is, the water repellent layer is preferably provided by plasma polymerization).

A metal nanoparticle that forms the metal nanoparticle layer is preferably a highly conductive metal, although not particularly limited thereto. Specific examples thereof include Au, Ag, Cu, Al, and Ni. Among those, Ag is preferred (that is, the metal nanoparticle layer is preferably a layer formed of silver nanoparticles). Although the size of the metal nanoparticle is not particularly limited, the particle diameter is preferably 1 to 100 nm. More specifically, in the case where the metal nanoparticle is a silver nanoparticle, the particle diameter is preferably 3 to 20 nm. The metal nanoparticle layer is preferably provided by dry film formation, although not particularly limited thereto. Specific examples thereof include vacuum evaporation and sputtering. Among those, sputtering is preferred (that is, the metal nanoparticle is preferably deposited on the water repellent layer by sputtering).

Although the material of the translucent layer is not particularly limited, a dielectric material is preferably used. Specific examples thereof include SiO₂, TiO₂, Al₂O₃, and SiO polymer (SiOx). The translucent layer is preferably provided by dry film formation, although not particularly limited thereto. Specific examples thereof include vacuum evaporation, plasma polymerization, and sputtering.

Although the material of the reflective layer is not particularly limited, a highly reflective metal material is preferably used. Specific examples thereof include Al, Ag, Ni, and Cr. The reflective layer is preferably provided by dry film formation, although not particularly limited thereto. Specific examples thereof include vacuum evaporation and sputtering.

In order to achieve the object, a method of manufacturing a decorative product including a plasmon film according to another aspect of the present invention includes: providing a water repellent layer having translucency on a back surface of a substrate having translucency by plasma polymerization; and stacking a metal nanoparticle layer as a plasmon film on a back surface of the water repellent layer by sputtering.

### Advantageous Effects of Invention

According to the above aspects of the present invention, a metal nanoparticle layer is stacked on a water repellent layer having small surface energy, thereby facilitating growth of metal nanoparticles into a granular state. This facilitates exhibition of a plasmon resonance phenomenon.

### BRIEF DESCRIPTION OF DRAWINGS

FIG. 1A is a perspective view showing a plasmon decorative product of Example 1, FIG. 1B is an exploded perspective view showing a lower portion thereof, FIG. 1C is a perspective view showing a plasmon decorative product of Comparative Example 1, and FIG. 1D is an exploded perspective view showing a lower portion thereof;

FIG. 2A is a perspective view showing a plasmon decorative product of Example 2, FIG. 2B is an exploded perspective view showing a lower portion thereof, FIG. 2C is a perspective view showing a plasmon decorative product of Comparative Example 2, and FIG. 2D is an exploded perspective view showing a lower portion thereof;

FIG. 3A is a perspective view showing a plasmon decorative product of Example 3, FIG. 3B is an exploded perspective view showing a lower portion thereof, FIG. 3C is a perspective view showing a plasmon decorative product of Comparative Example 3, and FIG. 3D is an exploded perspective view showing a lower portion thereof;

FIG. 4 is a graph showing chromatic values of the plasmon decorative products of Examples 1 to 5 and Comparative Examples 1 to 5; and

FIG. 5 shows photographs of a metal nanoparticle layer in Example 4 and a metal nanoparticle layer in Comparative Example 5.

### DESCRIPTION OF EMBODIMENTS

### EXAMPLE 1

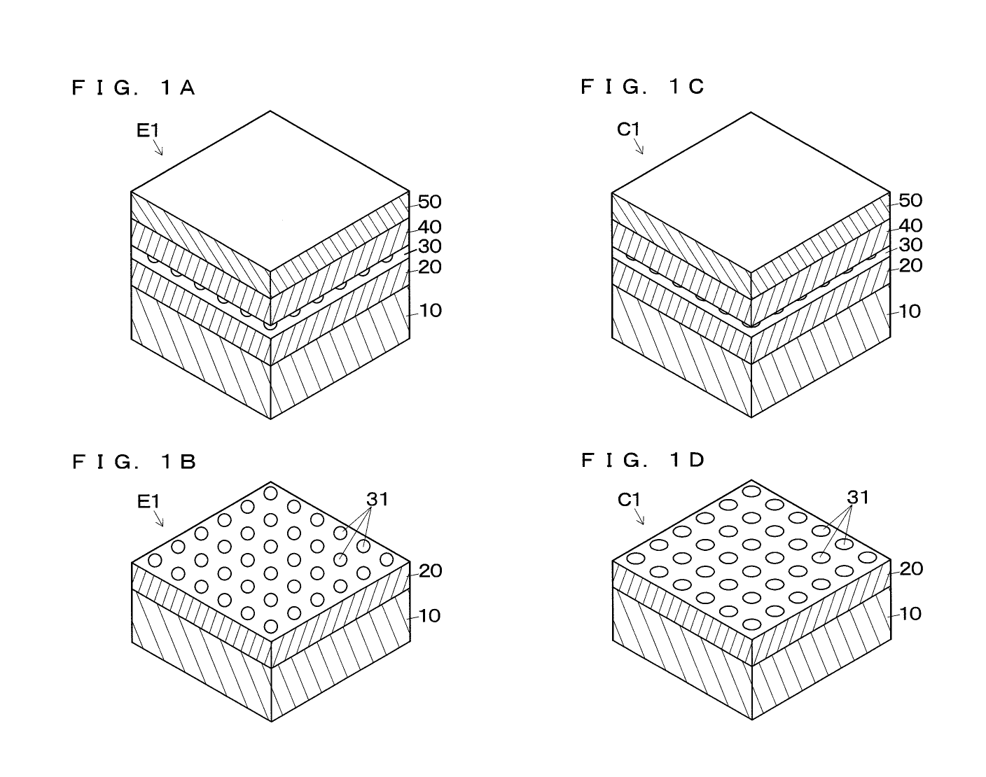

A plasmon decorative product E1 shown in FIGS. 1A and 1B is configured to include a transparent substrate 10, a first dielectric layer 20, a metal nanoparticle layer 30, a second dielectric layer 40, and a reflective layer 50 as shown below.

The transparent substrate 10 is a transparent mirror-finished substrate formed of, for example, glass, polycarbonate (PC), or polymethyl methacrylate (PMMA).

The first dielectric layer 20 is provided on the back surface of the transparent substrate 10. The first dielectric layer 20 is a layer formed of SiO polymer (SiOx) having a methyl group and is dielectric, translucent, and water repellent. The water contact angle of the first dielectric layer 20 is 100°.

The metal nanoparticle layer 30 is a conductive (highly conductive) layer formed such that silver nanoparticles 31 adhere on the back surface of the water repellent layer 20. This metal nanoparticle layer 30 forms a plasmon film that exhibits a plasmon resonance phenomenon to produce color.

The second dielectric layer 40 is provided on the back surface of the metal nanoparticle layer 30. The second dielectric layer 40 is a dielectric and translucent layer formed of SiO₂.

The reflective film 50 is provided on the back surface of the second dielectric layer 40. The reflective film 50 is an aluminum (Al) layer (metal film) and reflects light (highly reflective). In a case where a transparent color is produced to apply decoration with the transmitted light, the reflective film 50 may not be provided.

The procedure for manufacturing the plasmon decorative product E1 shown above is described below.

Film Formation of First Dielectric Layer 20

First, the transparent substrate 10 is prepared, and the first dielectric layer 20 is provided on the back surface of the transparent substrate 10. Here, dry film formation is performed by plasma polymerization using hexamethyldisiloxane (HMDSO) as a raw material. Specifically, a film having a film thickness of 10 nm was formed under conditions of a flow rate of 30 sccm (standard cc/min), RF power: 500W, and a film formation time: 100 seconds.

Film Formation of Metal Nanoparticle Layer 30

Next, the metal nanoparticle layer 30 is stacked on the back surface of the first dielectric layer 20. Here, the metal nanoparticle layer 30 is formed by a dry process by depositing silver nanoparticles 31 on the back surface of the first dielectric layer 20 by DC magnetron sputtering. Specifically, a film was formed under conditions of a plasma gas Ar flow rate: 500 sccm, DC power: 500W, and a film formation time: 5 seconds.

Film Formation of Second Dielectric Layer 40

Next, the second dielectric layer 40 is provided on the back surface of the metal nanoparticle layer 30. Here, dry film formation is performed by RF magnetron sputtering using SiO₂ as a raw material. Specifically, a film having a film thickness of 20 nm was formed under conditions of a plasma gas Ar flow rate: 30 sccm, RF power: 300W, and a film formation time: 120 seconds.

Film Formation of Reflective Layer 50

Next, the reflective layer 50 is provided on the back surface of the second dielectric layer 40. Here, dry film formation is performed by DC magnetron sputtering using Al as a raw material. Specifically, a film having a film thickness of 50 nm was formed under conditions of a plasma gas Ar flow rate: 30 sccm, DC power: 500W, and a film formation time: 90 seconds.

In order to objectively determine the features of the plasmon decorative product E1 of Example 1 manufactured as described above, a plasmon decorative product C1 of Comparative Example 1 shown in FIGS. 1C and 1D was also manufactured. The plasmon decorative product C1 of Comparative Example 1 differs from the plasmon decorative product E1 of Example 1 in that the first dielectric layer 20 is formed of SiO₂ rather than SiO polymer (SiOx), the water contact angle of the first dielectric layer 20 is 14° rather than 100°, and the first dielectric layer 20 is formed by a dry process using SiO₂ as a raw material by RF magnetron sputtering (a plasma gas Ar flow rate: 30 sccm, RF power: 300 W, a film formation time: 60 seconds, a film thickness: 10 nm) rather than plasma polymerization. In other points, the plasmon decorative product C1 of Comparative Example 1 is the same as the plasmon decorative product E1 of Example 1.

The result of comparison between the plasmon decorative product E1 of Example 1 and the plasmon decorative product C1 of Comparative Example 1 is as follows. First, as a result of visual comparison, the plasmon decorative product E1 of Example 1 was more vibrant yellow than the plasmon decorative product C1 of Comparative Example 1. As for the chromatic values actually measured, the value of √(a²+b²) indicative of the intensity of color was 13.59 in the plasmon decorative product C1 of Comparative Example 1, whereas 20.70 in the plasmon decorative product E1 of Example 1. That is, the chromatic value was higher in Example 1. Specifically, in the plasmon decorative product C1 of Comparative Example 1, the value a indicative of the intensity of red or green (a larger positive value indicates deeper red, and a larger negative value indicates deeper green) was 8.62 (red) and the value b indicative of the intensity of yellow or blue (a larger positive value indicates deeper yellow, and a larger negative value indicates deeper blue) was 10.50 (yellow). By contrast, in the plasmon decorative product E1 of Example 1, the value a was 0.07 (red) and the value b was 20.70 (yellow).

### EXAMPLE 2

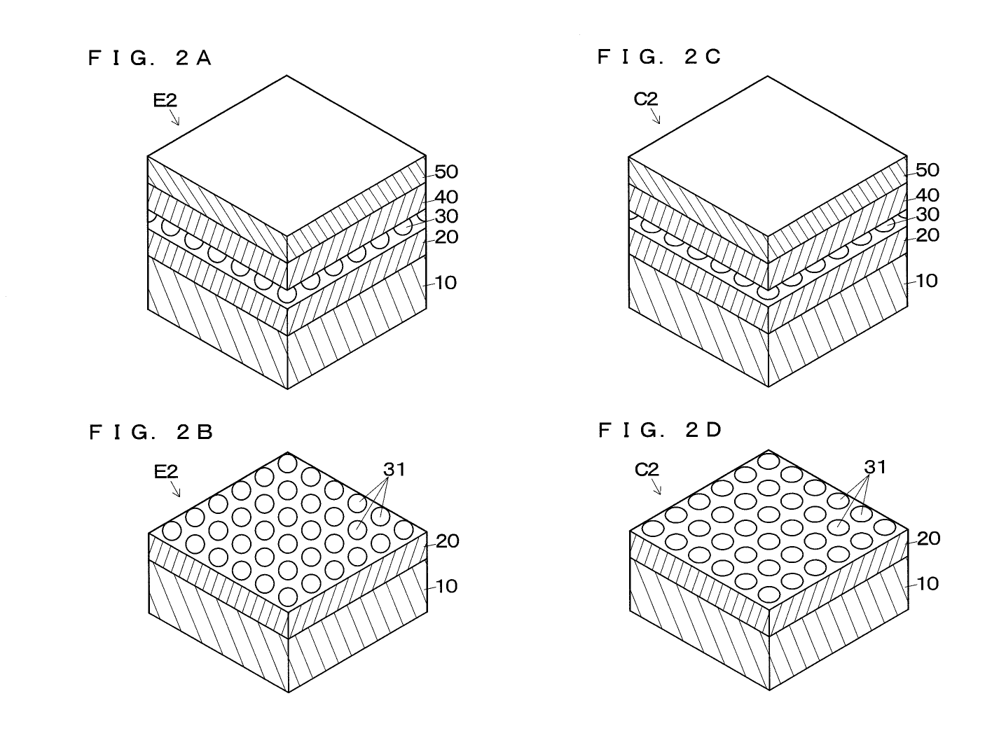

A plasmon decorative product E2 of Example 2 shown in FIGS. 2A and 2B differs from the plasmon decorative product E1 of Example 1 in the film thickness of the metal nanoparticle layer 30 and that the film formation time was 7 seconds rather than 5 seconds. In other points, the plasmon decorative product E2 of Example 2 is the same as the plasmon decorative product E1 of Example 1.

In order to objectively determine the features of the plasmon decorative product E2 of Example 2, a plasmon decorative product C2 of Comparative Example 2 shown in FIGS. 2C and 2D was also manufactured. The plasmon decorative product C2 of Comparative Example 2 differs from the plasmon decorative product E2 of Example 2 in that the first dielectric layer 20 is formed of SiO₂ rather than SiO polymer and that the water contact angle of the first dielectric layer 20 is 14° rather than 100°, and in the film formation method (the same as in Comparative Example 1). In other points, the plasmon decorative product C2 of Comparative Example 2 is the same as the plasmon decorative product E2 of Example 2.

The result of comparison between the plasmon decorative product E2 of Example 2 and the plasmon decorative product C2 of Comparative Example 2 is as follows. First, as a result of visual comparison, the plasmon decorative product E2 of Example 2 was more vibrant red than the plasmon decorative product C2 of Comparative Example 2. As for the chromatic values actually measured, the value of √(a²+b²) indicative of the intensity of color was 18.50 in the plasmon decorative product C2 of Comparative Example 2, whereas 23.22 in the plasmon decorative product E2 of Example 2. That is, the chromatic value was higher in Example 2. Specifically, in the plasmon decorative product C2 of Comparative Example 2, the value a was 18.36 (red) and the value b was −2.27 (blue). By contrast, in the plasmon decorative product E2 of Example 2, the value a was 20.18 (red) and the value b was 11.49 (yellow).

### EXAMPLE 3

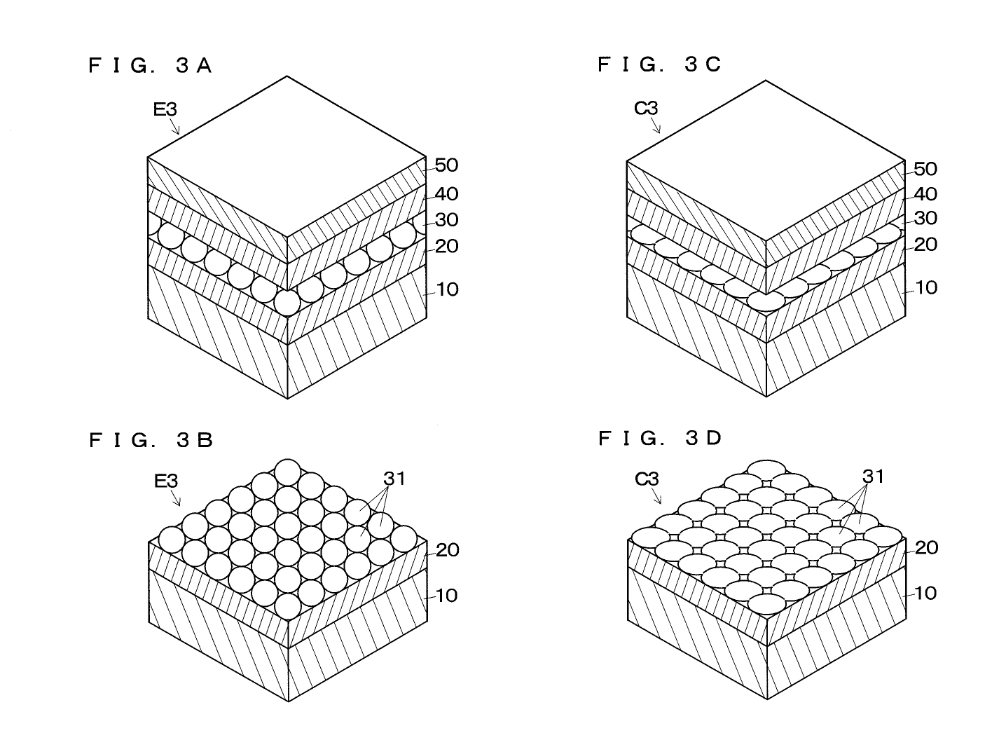

A plasmon decorative product E3 of Example 3 shown in FIGS. 3A and 3B differs from the plasmon decorative product E1 of Example 1 in the film thickness of the metal nanoparticle layer 30 and that the film formation time was 15 seconds rather than 5 seconds. In other points, the plasmon decorative product E3 of Example 3 is the same as the plasmon decorative product E1 of Example 1.

In order to objectively determine the features of the plasmon decorative product E3 of Example 3, a plasmon decorative product C3 of Comparative Example 3 shown in FIGS. 3C and 3D was also manufactured. The plasmon decorative product C3 of Comparative Example 3 differs from the plasmon decorative product E3 of Example 3 in that the first dielectric layer 20 is formed of SiO₂ rather than SiO polymer and that the water contact angle of the first dielectric layer 20 is 14° rather than 100°, and in the film formation method (the same as in Comparative Example 1). In other points, the plasmon decorative product C3 of Comparative Example 3 is the same as the plasmon decorative product E3 of Example 3.

The result of comparison between the plasmon decorative product E3 of Example 3 and the plasmon decorative product C3 of Comparative Example 3 is as follows. First, as a result of visual comparison, the plasmon decorative product E3 of Example 3 was more vibrant blue than the plasmon decorative product C3 of Comparative Example 3. As for the chromatic values actually measured, the value of √(a²+b²) indicative of the intensity of color was 9.38 in the plasmon decorative product C3 of Comparative Example 3, whereas 20.31 in the plasmon decorative product E3 of Example 3. That is, the chromatic value was higher in Example 3. Specifically, in the plasmon decorative product C3 of Comparative Example 3, the value a was 0.72 (red) and the value b was −9.35 (blue). By contrast, in the plasmon decorative product E3 of Example 3, the value a was −0.41 (green) and the value b was −20.31 (blue).

### EXAMPLE 4

A plasmon decorative product E4 of Example 4 differs from the plasmon decorative product E3 of Example 3 in that the film thickness of the second dielectric film 40 was 40 nm rather than 20 nm and that the film formation time for the second dielectric film 40 was 240 seconds rather than 120 seconds. In other points, the plasmon decorative product E4 of Example 4 is the same as the plasmon decorative product E3 of Example 3.

In order to objectively determine the features of the plasmon decorative product E4 of Example 4, a plasmon decorative product C4 of Comparative Example 4 was also manufactured. The plasmon decorative product C4 of Comparative Example 4 differs from the plasmon decorative product E4 of Example 4 in that the first dielectric layer 20 is formed of SiO₂ rather than SiO polymer and that the water contact angle of the first dielectric layer 20 is 14° rather than 100°, and in the film formation method (the same as in Comparative Example 1). In other points, the plasmon decorative product C4 of Comparative Example 4 is the same as the plasmon decorative product E4 of Example 4.

The result of comparison between the plasmon decorative product E4 of Example 4 and the plasmon decorative product C4 of Comparative Example 4 is as follows. First, as a result of visual comparison, the plasmon decorative product E4 of Example 4 was more vibrant blue than the plasmon decorative product C4 of Comparative Example 4. As for the chromatic values actually measured, the value of √(a²+b²) indicative of the intensity of color was 13.42 in the plasmon decorative product C4 of Comparative Example 4, whereas 33.83 in the plasmon decorative product E4 of Example 4. That is, the chromatic value was higher in Example 4. Specifically, in the plasmon decorative product C4 of Comparative Example 4, the value a was 0.18 (red) and the value b was −13.42 (blue). By contrast, in the plasmon decorative product E4 of Example 4, the value a was 5.22 (red) and the value b was −33.42 (blue).

### EXAMPLE 5

A plasmon decorative product E5 of Example 5 differs from the plasmon decorative product E4 of Example 4 in the film thickness of the metal nanoparticle layer 30 and that the film formation time was 20 seconds rather than 15 seconds. In other points, the plasmon decorative product E5 of Example 5 is the same as the plasmon decorative product E4 of Example 4.

In order to objectively determine the features of the plasmon decorative product E5 of Example 5, a plasmon decorative product C5 of Comparative Example 5 was also manufactured. The plasmon decorative product C5 of Comparative Example 5 differs from the plasmon decorative product E5 of Example 5 in that the first dielectric layer 20 is formed of SiO₂ rather than SiO polymer and that the water contact angle of the first dielectric layer 20 is 14° rather than 100°, and in the film formation method (the same as in Comparative Example 1). In other points, the plasmon decorative product C5 of Comparative Example 5 is the same as the plasmon decorative product E5 of Example 5.

The result of comparison between the plasmon decorative product E5 of Example 5 and the plasmon decorative product C5 of Comparative Example 5 is as follows. First, as a result of visual comparison, the plasmon decorative product E5 of Example 5 was more vibrant blue than the plasmon decorative product C5 of Comparative Example 5. As for the chromatic values actually measured, the value of √(a²+b²) indicative of the intensity of color was 2.09 in the plasmon decorative product C5 of Comparative Example 5, whereas 11.04 in the plasmon decorative product E5 of Example 5. That is, the chromatic value was higher in Example 5. Specifically, in the plasmon decorative product C5 of Comparative Example 5, the value a was 2.08 (red) and the value b was 0.25 (yellow). By contrast, in the plasmon decorative product E5 of Example 5, the value a was −3.31 (green) and the value b was −10.53 (blue).

The results of these Examples 1 to 5 and Comparative Examples 1 to 5 are summarized in Table 1 below.

TABLE 1

| | Condition | | | | | | | | |
|---|---|---|---|---|---|---|---|---|---|
| | First dielectric | | | | | | Second dielectric | | |
| | layer | | | | | | layer | | |
| | | Film | | Metal layer | | | | Film | |
| | | thick- | Contact | | | Particle | | thick- | Contact |
| | | ness | angle | | Time | diameter | | ness | angle |
| Sample No. | Material | [nm] | [°] | Material | [sec] | [nm] | Material | [nm] | [°] |
| Comparative | SiO2 | 10 | 14 | Ag | 5.0 | 5 | SiO2 | 20.0 | 14 |
| Example 1 | | | | | | | | | |
| Example 1 | SiOx | 10 | 100 | Ag | 5.0 | — | SiO2 | 20.0 | 14 |
| Comparative | SiO2 | 10 | 14 | Ag | 7.0 | 7 | SiO2 | 20.0 | 14 |
| Example 2 | | | | | | | | | |
| Example 2 | SiOx | 10 | 100 | Ag | 7.0 | — | SiO2 | 20.0 | 14 |
| Comparative | SiO2 | 10 | 14 | Ag | 15.0 | — | SiO2 | 20.0 | 14 |
| Example 3 | | | | | | | | | |
| Example 3 | SiOx | 10 | 100 | Ag | 15.0 | — | SiO2 | 20.0 | 14 |
| Comparative | SiO2 | 10 | 14 | Ag | 15.0 | — | SiO2 | 40.0 | 14 |
| Example 4 | | | | | | | | | |
| Example 4 | SiOx | 10 | 100 | Ag | 15.0 | 15 | SiO2 | 40.0 | 14 |
| Comparative | SiO2 | 10 | 14 | Ag | 20.0 | 15 | SiO2 | 40.0 | 14 |
| Example 5 | | | | | | | | | |
| Example 5 | SiOx | 10 | 100 | Ag | 20.0 | — | SiO2 | 40.0 | 14 |

| | Condition | | | | | | |
|---|---|---|---|---|---|---|---|
| | Reflective | | | | | | |
| | layer | | | | | | |
| | | Film | | | | | |
| | | thick- | Result | | | | |
| | | ness | Chromatic value | | | | Visual |
| Sample No. | Material | [nm] | L | a | b | √(a² + b²) | Judgment |
| Comparative | Al | 50 | 60.15 | 8.62 | 10.50 | 13.59 | Δ |
| Example 1 | | | | | | | |
| Example 1 | Al | 50 | 77.71 | 0.07 | 20.70 | 20.70 | ◯ |
| Comparative | Al | 50 | 51.76 | 18.36 | −2.27 | 18.50 | Δ |
| Example 2 | | | | | | | |
| Example 2 | Al | 50 | 62.90 | 20.18 | 11.49 | 23.22 | ◯ |
| Comparative | Al | 50 | 55.33 | 0.72 | −9.35 | 9.38 | Δ |
| Example 3 | | | | | | | |
| Example 3 | Al | 50 | 50.65 | −0.41 | −20.31 | 20.31 | ◯ |
| Comparative | Al | 50 | 40.70 | 0.18 | −13.42 | 13.42 | Δ |
| Example 4 | | | | | | | |
| Example 4 | Al | 50 | 34.63 | 5.22 | −33.42 | 33.83 | ◯ |
| Comparative | Al | 50 | 58.57 | 2.08 | 0.25 | 2.09 | X |
| Example 5 | | | | | | | |
| Example 5 | Al | 50 | 50.44 | −3.31 | −10.53 | 11.04 | ◯ |

The values shown in the column L of chromatic values indicate the value L (lightness).

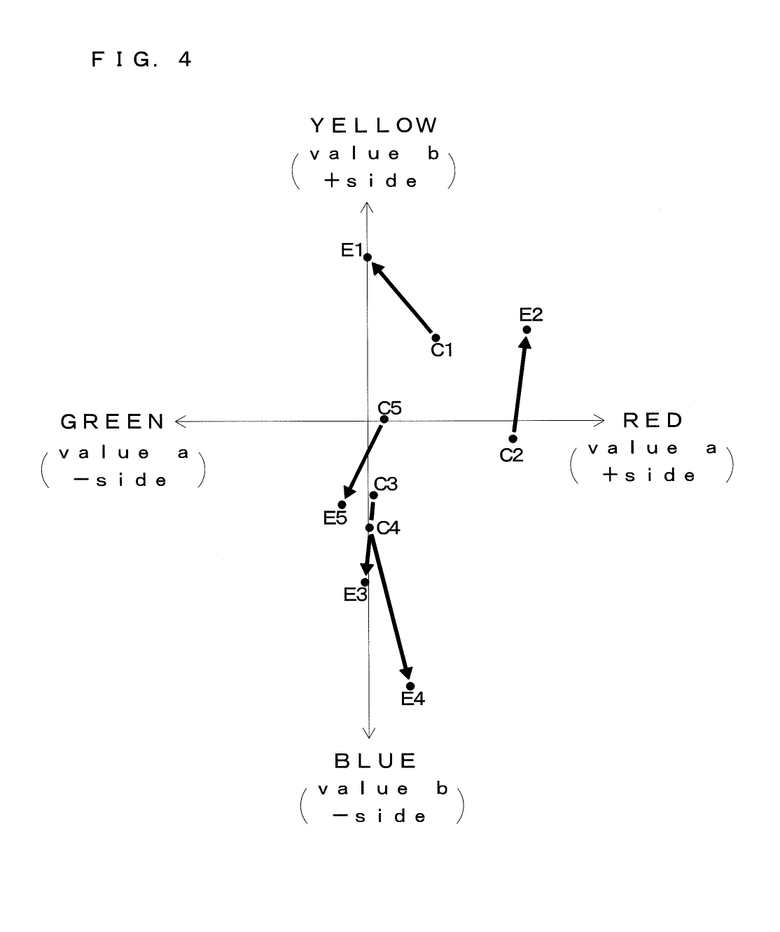

FIG. 4 is a graph collectively showing the chromatic values of Examples 1 to 5 and Comparative Examples 1 to 5, in which the axis of abscissas shows the value a (the intensity of red or green), and the axis of ordinates shows the value b (the intensity of yellow or blue). This graph shows that coordinates closer to the origin (0, 0) represent the paler color, and coordinates further away from the origin represent the deeper color. All the arrows extending from Comparative Examples toward the corresponding Examples point the direction further away from the origin. Based on this, it is understood that the colors in Examples are all deeper than those in the corresponding Comparative Examples.

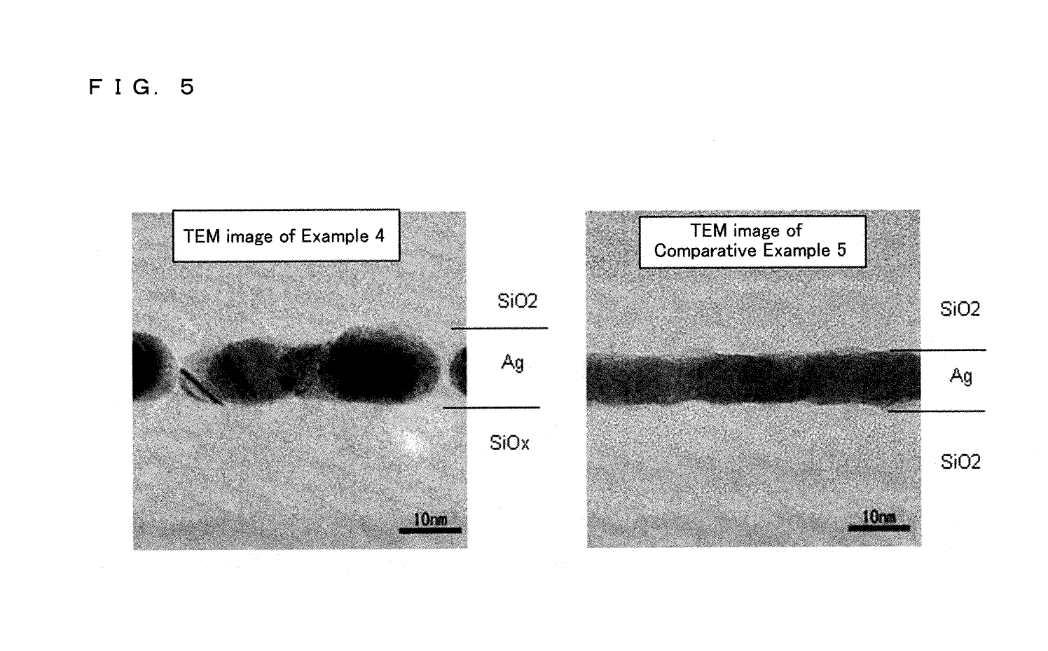

FIG. 5 shows photographs of the metal nanoparticle layer 30 of Example 4 and the metal nanoparticle layer 30 of Comparative Example 5. According to those photographs, when compared with the plasmon decorative product C5 of Comparative Example 5 on the right side in which the value of √(a²+b²) indicative of the intensity of color is 2.09, the particles in the metal nanoparticle layer are larger in the vertical direction and sparse (formed in a granular state) in the plasmon decorative product E4 of Example 4 on the left side in which the value of √(a²+b²) is 33.83. This observation result shows that color produced by a plasmon resonance phenomenon is more vibrant because of large and sparse particles.

As described above, in Examples 1 to 5, the first dielectric layer 20 was formed as a water repellent layer having the water contact angle of 100°, thereby facilitating exhibition of a plasmon resonance phenomenon. This is possibly because silver nanoparticles 31 are deposited and grown on the water repellent layer (the first dielectric layer 20) having small surface energy, so that silver nanoparticles 31 are easily grown in a granular state. Such improvement is conspicuous in blue (Examples 3 to 5), which has not been produced well conventionally, in particular.

The present invention is not limited to the foregoing Examples and can be modified as appropriate and embodied within a scope that does not depart from the spirit of the invention.

### REFERENCE SIGNS LIST

10 transparent substrate (substrate)
20 first dielectric layer (water repellent layer)
30 metal nanoparticle layer
40 second dielectric layer (translucent layer)
50 reflective layer
E1 plasmon decorative product (Example 1)
E2 plasmon decorative product (Example 2)
E3 plasmon decorative product (Example 3)
E4 plasmon decorative product (Example 4)
E5 plasmon decorative product (Example 5)
C1 plasmon decorative product (Comparative Example 1)
C2 plasmon decorative product (Comparative Example 2)
C3 plasmon decorative product (Comparative Example 3)
C4 plasmon decorative product (Comparative Example 4)
C5 plasmon decorative product (Comparative Example 5)

1. A decorative product including a plasmon film, comprising:
a water repellent layer; and
a metal nanoparticle layer as the plasmon film stacked on the water repellent layer.

2. The decorative product including a plasmon film according to claim 1, wherein the water repellent layer is a layer formed of a SiO polymer.

3. The decorative product including a plasmon film according to claim 2, wherein the SiO polymer includes a methyl group.

4. The decorative product including a plasmon film according to claim 3, wherein the metal nanoparticle layer is a layer formed of silver nanoparticles.

5. The decorative product including a plasmon film according to claim 4, further comprising:
a substrate having translucency, wherein
the water repellent layer is provided on a back surface of the substrate and has translucency, and the metal nanoparticle layer is stacked on a back surface of the water repellent layer.

6. The decorative product including a plasmon film according to claim 5, wherein a translucent layer having translucency is provided on a back surface of the metal nanoparticle layer, and a reflective layer that reflects light is provided on a back surface of the translucent layer.

7. The decorative product including a plasmon film according to claim 1, wherein the metal nanoparticle layer is a layer formed of silver nanoparticles.

8. The decorative product including a plasmon film according to claim 7, further comprising:
a substrate having translucency, wherein
the water repellent layer is provided on a back surface of the substrate and has translucency, and the metal nanoparticle layer is stacked on a back surface of the water repellent layer.

9. The decorative product including a plasmon film according to claim 8, wherein a translucent layer having translucency is provided on a back surface of the metal nanoparticle layer, and a reflective layer that reflects light is provided on a back surface of the translucent layer.

10. The decorative product including a plasmon film according to claim 1, further comprising:
a substrate having translucency, wherein
the water repellent layer is provided on a back surface of the substrate and has translucency, and the metal nanoparticle layer is stacked on a back surface of the water repellent layer.

11. The decorative product including a plasmon film according to claim 10, wherein a translucent layer having translucency is provided on a back surface of the metal nanoparticle layer, and a reflective layer that reflects light is provided on a back surface of the translucent layer.

12. The decorative product including a plasmon film according to claim 1, wherein a translucent layer having translucency is provided on a back surface of the metal nanoparticle layer, and a reflective layer that reflects light is provided on a back surface of the translucent layer.

13. A method of manufacturing a decorative product including a plasmon film, the method comprising:
providing a water repellent layer having translucency on a back surface of a substrate having translucency by plasma polymerization; and
stacking a metal nanoparticle layer as the plasmon film on a back surface of the water repellent layer by sputtering.
